(19) United States
(12) Patent Application Publication
(10) Pub. No.: US 2004/0264119 A1
(43) Pub. Date: Dec. 30, 2004

(54) Electronic apparatus

(75) Inventor: Toshiyuki Hirota, Hino-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/814,272

(22) Filed: Apr. 1, 2004

(30) Foreign Application Priority Data
Jun. 30, 2003 (JP) 2003-188499

(51) Int. Cl. G06F 1/16

(52) U.S. Cl. 361/683

(57) ABSTRACT

An electronic apparatus includes a casing, and a display panel located in the casing. A circuit board for the display panel is arranged in the casing. An antenna element is arranged in the casing and mounted on the circuit board. A radio communication device is connected to the antenna element.

### CROSS-REFERENCE TO RELATED APPLICATIONS

This application is based upon and claims the benefit of priority from prior Japanese Patent Application No. 2003-188499, filed Jun. 30, 2003, the entire contents of which are incorporated herein by reference.

### BACKGROUND OF THE INVENTION

1. Field of the Invention

The present invention relates to electronic apparatuses, such as portable computers, portable remote terminals, mobile communication equipments, etc., and more particularly, to an electronic apparatus having a radio communication function.

2. Description of the Related Art

Recently, notebook-sized portable computers having radio communication functions, such as a radio LAN, Bluetooth, etc., have been developed as electronic apparatuses. In general, a portable computer comprises a computer body and a display unit that is rockably mounted on the body. For example, the radio LAN for radio communication comprises a radio communication device, which includes an RF portion and a base band portion, and an antenna connected to the communication device. Normally, the antenna is attached to the display unit, while the radio communication device is located in the computer body. Thus, the mounting position for the antenna is isolated from a desk or the like on which the computer body is placed, whereby a satisfactory environment for radio waves is secured.

A diversity-type radio LAN is described in U.S. Pat. No. 6,456,499 or Jpn. Pat. Appln. KOKAI Publication No. 2002-73210, for example. It has two antennas, both of which are located in a display unit. Further, the Bluetooth has recently been developed as a near radio communication system, and a portable computer that is furnished with the Bluetooth in addition to the radio LAN has been also developed. In this case, an antenna for the Bluetooth is mounted together with an antenna for the radio LAN in a display unit.

In the portable computer with the radio function, as described above, a plurality of antennas are arranged in the display unit. In order to secure a plurality of radio communication systems hereafter, it is necessary to mount more antennas. However, a portable computer of the notebook-sized type or the like must positively be reduced in size and thickness, so that its display unit is thinned and narrowed. Further, the display unit contains a backlight unit including a fluorescent lamp, an inverter for the lamp, etc., as well as a liquid crystal display panel. It is difficult, therefore, to secure a space that is wide enough to mount a plurality of antennas in the display unit. In mounting novel radio communication devices, such as the ultra wide band (UWB), general packet radio service (GPRS), etc., as well as a radio LAN, Bluetooth, etc., hereafter, it will be more difficult to secure the antenna mounting space.

Likewise, it is hard to secure satisfactory spaces for mounting a plurality of radio communication devices on the computer body side. Further, a mounting structure for the radio communication device, including antennas, must be disposed in the portable computer. Accordingly, the construction of the computer is complicated, and a wider mounting space is required.

If the radio communication device and the antennas are attached to the body and the display unit of the optical component, respectively, a cable that connects them is relatively long. Thus, deterioration in performance, such as signal attenuation, is caused, and the cost of the cable is nonnegligible. If a high-sensitivity radio communication device, such as a portable telephone, is mounted in the portable computer, moreover, noises that are picked up by the cable are also nonnegligible.

### BRIEF SUMMARY OF THE INVENTION

According to an aspect of the invention, an electronic apparatus comprises a casing; a display panel located in the casing; a circuit board for the display panel located in the casing; an antenna element mounted on the circuit board in the casing; and a radio communication device connected to the antenna element.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable computer according to a first embodiment of the invention;

FIG. 2 is a block diagram schematically showing a radio communication device and an antenna element in the portable computer;

FIG. 3 is a block diagram schematically showing the internal configuration of the body of the portable computer;

FIG. 4 is a perspective view showing an inverter in the portable computer;

FIG. 5 is a side view showing the inverter;

FIG. 6 is a side view showing an inverter in a portable computer according to a second embodiment of the invention;

FIG. 7 is a side view showing an inverter in a portable computer according to a third embodiment of the invention;

FIG. 8 is a side view showing an inverter in a portable computer according to a fourth embodiment of the invention;

FIG. 9 is a side view showing an inverter and an antenna element in a portable computer according to a fifth embodiment of the invention;

FIG. 10 is a side view showing an inverter and an antenna element in a portable computer according to a sixth embodiment of the invention; and

FIG. 11 is a side view showing an inverter and an antenna element in a portable computer according to a seventh embodiment of the invention.

### DETAILED DESCRIPTION OF THE INVENTION

A portable computer as an electronic apparatus according to a first embodiment of the present invention will now be described in detail with reference to the accompanying drawings.

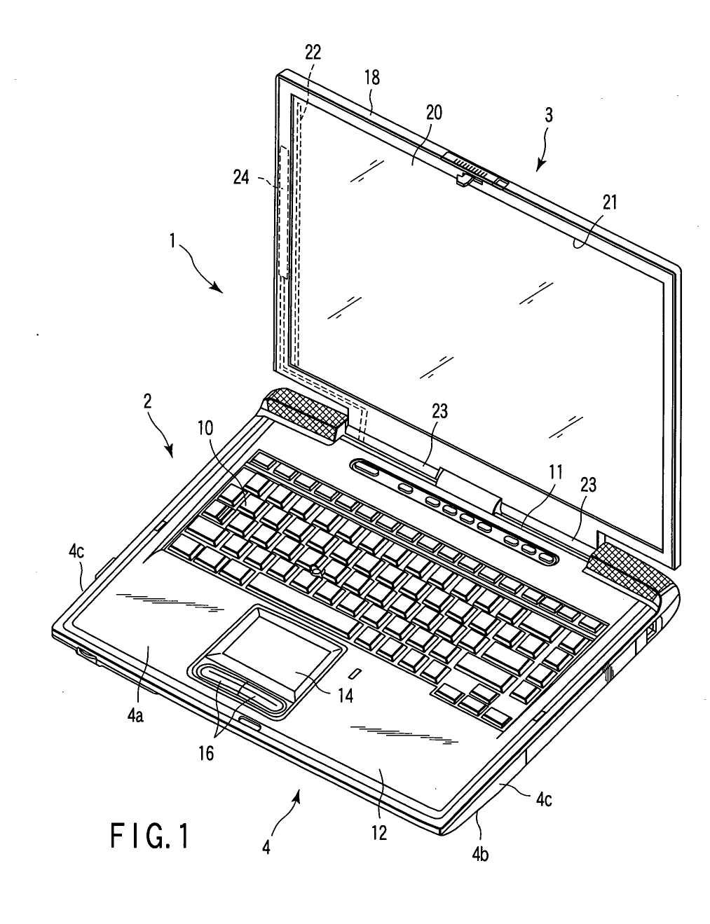

As shown in FIG. 1, a portable computer 1 comprises a computer body 2 and a display unit 3 that is mounted on the body 2. The computer body 2 is provided with a first casing 4 that is formed of synthetic resin, for example. The first casing 4 is in the form of a flat box, which has a top wall 4a, bottom wall 4b, left- and right-hand sidewalls 4c, front wall 4d, and rear wall 4e. A keyboard 10 is provided on the central portion of the top wall 4a, and various indicators 11 are arranged on the rear end portion of the top surface. The front end portion of the top wall 4a forms a palm rest portion 12, and a touch pad 14 and click buttons 16 are arranged substantially in the center of the palm rest portion.

The display unit 3 is provided with a second casing 18 in the form of a flat rectangular box and a liquid crystal display panel 20 located in the second casing. The panel 20 is exposed to the outside through a display window 21 in the second casing 18. The second casing 18 has a pair of leg portions 23 that protrude from its one end portion. These leg portions 23 are rockably supported on the rear end portion of the first casing 4 by means of hinge portions (not shown). Thus, the display unit 3 is rockable between a closed position in which it is flattened to cover the keyboard 10 from above and an open position in which it stands upright at the back of the keyboard 10.

The second casing 18 of the display unit 3 contains driver circuits 25 for driving the liquid crystal display panel 20, an elongate fluorescent lamp 22 as a light source for lighting the panel 20, and an inverter 24 for driving the fluorescent lamp. The driver circuits 25 have their respective printed circuit boards (not shown), and are arranged individually along side edges of the liquid crystal display panel. The inverter 24 is located beside the liquid crystal display panel 20 in the second casing 18. Alternatively, the inverter 24 may be located over, under, or at the back of the panel 20 in an overlapping manner.

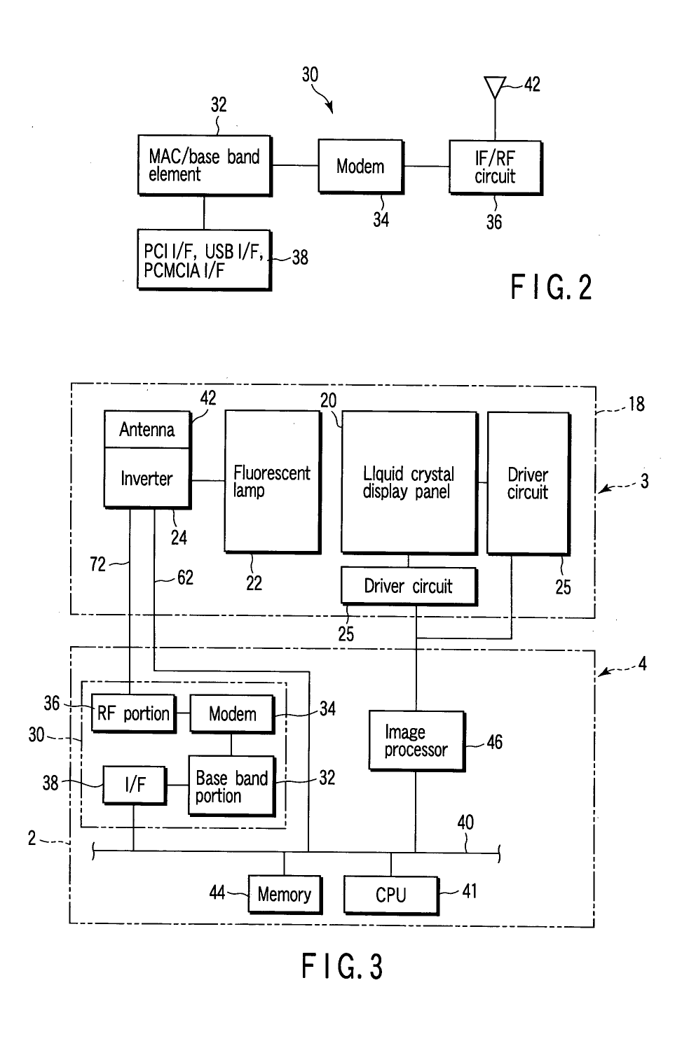

Further, the portable computer 1 comprises a radio communication device 30, which constitutes a radio LAN, and an antenna element 42. As shown in FIGS. 2 and 3, the radio communication device 30 is provided with an MAC (media access control)/base band element 32, a modem 34, and an IF (intermediate frequency)/RF (radio frequency) circuit 36. The MAC/base band element 32 is connected to a CPU bus 40 on a system board in the computer body 2 through an interface (I/F) 38. The IF/RF circuit 36 is connected to the antenna element 42 by a cable.

The MAC/base band element 32 is divided into two blocks, an MAC portion situated on the I/F side and a base band portion on the modem side. The MAC portion generates a framed signal, while the base band portion modulates a constructed frame and generates I (in-phase component) and Q (orthogonal component) signals.

In signal transmission, the MAC/base band element 32 frames a digital signal that is transmitted from a CPU 41 through the CPU bus 40, thereby modulating the signal. I and Q base band signals for the modulated signal are generated. After the base band signals are converted into I and Q analog signals by means of a DA converter, they are delivered to the modem 34.

In signal reception, the MAC/base band element 32 converts the I and Q analog signals received from the modem 34 into digital signals by means of an AD converter and demodulates them into signals that are suited for the I/F 38.

In signal transmission, the modem 34 mixes and modulates the I and Q analog signals that are received from the MAC/base band element 32, thereby generating intermediate frequency band signals, and delivers the signals to the IF/RF circuit 36. In signal reception, on the other hand, the modem 34 demodulates the intermediate frequency band signals that are received from the IF/RF circuit 36, thereby generating I and Q analog signals, and delivers the signals to the MAC/base band element 32.

In signal transmission, the IF/RF circuit 36 that functions as an RF portion enhances the frequencies of the analog signals received from the modem 34 to a target frequency band, 2.4 GHz, and generates signals to be actually transmitted from the antenna element 42. Then, the IF/RF circuit 36 amplifies the signals and transmits them to the antenna element 42. In signal reception, the IF/RF circuit 36 amplifies and demodulates the signals that are received by the antenna element 42, thereby lowering their frequencies to an intermediate frequency band.

Thus, the I and Q analog signals at relatively low frequencies of several megahertz to tens of megahertz are transferred between the MAC/base band element 32 and the modem 34. Intermediate frequency signals at hundreds of megahertz are transferred between the modem 34 and the IF/RF circuit 36. Further, high frequency signals in the 2.4-GHz band are transferred between the IF/RF circuit 36 and the antenna element 42.

A PCI I/F, USB I/F, or PCMCIA I/F may be used as the I/F 38, depending on the communication system and usage.

The MAC/base band element 32, modem 34, and IF/RF circuit 36 that constitute the radio communication device 30 are arranged in the body 2 of the portable computer 1 and mounted on the system board (not shown). The radio communication device 30 is connected to the CPU bus 40 through the I/F 38. The CPU bus 40 is connected with the CPU 41 of the portable computer 1, a memory 44 loaded with received data and transmit data, and the like. Besides, an image processor 46 for processing images that are displayed on the liquid crystal display panel 20 is disposed in the computer body 2.

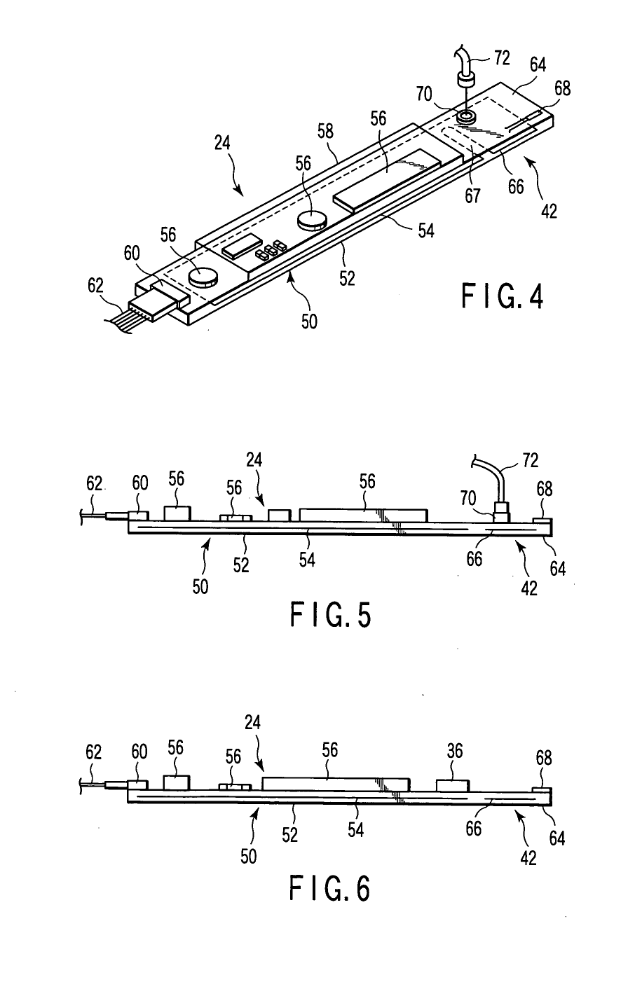

The antenna element 42 that radiates and receives radio waves is located in the second casing 18 of the display unit 3 and constructed integrally with the inverter 24. As shown in FIGS. 4 and 5, the inverter 24 is provided with a printed circuit board 50 in the form of an elongated rectangular. The printed circuit board 50 has an insulating layer 52 formed of polyimide or glass epoxy, a wiring pattern (not shown) formed on the insulating layer, and a ground pattern 54. The ground pattern 54 is formed in the insulating layer 52, substantially covering its whole area. The printed circuit board 50 of the inverter 24 functions as a circuit board for a display panel.

Electronic components 56 are mounted on the wiring pattern. A transparent shielding cover 58 that is attached to the printed circuit board 50 covers some of the electronic components 56. A connector 60 is mounted on one end of the circuit board 50 with respect to its longitudinal direction, and wires 62 are connected to the connector.

The antenna element 42 is formed as a board-mounted antenna, for example, and is mounted on the printed circuit board 50 of the inverter 24. More specifically, the antenna element 42 has an insulating substrate 64 that serves as an antenna board. The insulating substrate 64 is formed of a part of the circuit board 50. In this case, the insulating substrate 64 is formed of one end portion of the circuit board 50 with respect to its longitudinal direction, which is situated on the side remoter from the connector 60. A ground pattern 66 is formed in the insulating substrate 64, substantially covering its whole area. The ground pattern 66 is connected to the ground pattern 54 of the inverter 24. Formed between the ground patterns 54 and 66 is a slit 67 that extends at right angles to the longitudinal direction of the printed circuit board 50.

The antenna element 42 is provided with a chip antenna 68 on the insulating substrate 64 and a coaxial connector 70 connected to the chip antenna. The antenna element 42 is connected to the IF/RF circuit 36 in the computer body 2 by means of a coaxial cable 72 that is connected to the coaxial connector 70. The antenna itself is not limited to a chip antenna, and may alternatively be an antenna formed of sheet metal or strip lines.

As shown in FIGS. 1 and 3, the inverter 24 is set in the second casing 18 so as to be situated beside the liquid crystal display panel 20 and extends along a side edge of the second casing. The inverter 24 is located so that its end portion connected with the connector 60 is situated below the antenna element 42 when the display unit 3 is set upright in the open position. The inverter 24 is connected to a power source for the computer body 2 and the CPU bus 40 by the wires 62. The wires 62 and the coaxial cable 72 are drawn into the first casing 4 of the computer body 2 through the leg portions 23 of the second casing 18.

In transmitting data by the radio LAN in the portable computer constructed in this manner, the CPU 41 loads the memory 44 with the transmit data. Then, the CPU 41 transmits the stored digital transmit data to the radio communication device 30 through the CPU bus 40 and the I/F 38.

In the radio communication device 30, the MAC/base band element 32 modulates the inputted transmit data to generate base band signals. After the base band signals are converted into analog signals by means of the DA converter, they are delivered to the modem 34. The modem 34 mixes and modulates the I and Q analog signals that are received from the MAC/base band element 32, thereby generating intermediate frequency band signals, and delivers the signals to the IF/RF circuit 36.

The IF/RF circuit 36 enhances the frequencies of the analog signals received from the modem 34 to the target frequency band, 2.4 GHz, and generates signals to be transmitted from the antenna element 42. Then, the IF/RF circuit 36 amplifies the signals and delivers them to the antenna element 42 through the coaxial cable 72. Thus, the transmit data are transmitted from the chip antenna 68 of the antenna element 42.

In receiving data from the radio LAN, on the other hand, the data received by the chip antenna 68 of the antenna element 42 are delivered to the IF/RF circuit 36 by means of the coaxial cable 72. The IF/RF circuit 36 amplifies and demodulates the inputted received data, thereby lowering their frequencies to the intermediate frequency band, and then delivers them to the modem 34. The modem 34 demodulates the intermediate frequency band signals that are received from the IF/RF circuit 36, thereby generating I and Q analog signals, and delivers the signals to the MAC/base band element 32.

The MAC/base band element 32 converts the I and Q analog signals received from the modem 34 into digital signals by means of the AD converter, demodulates them into signals that are suited for the I/F 38, and then delivers them to the CPU bus 40 through the I/F. The received data delivered to the CPU bus 40 are loaded into the memory 44.

According to the portable computer 1 constructed in this manner, the antenna element for radio communication is mounted on the board of the inverter 24 so that a part of the inverter board serves also as the antenna element. Thus, the mounting space for the antenna element in the display unit 3 can be reduced. Although a chip antenna of a board-mounted antenna is small-sized, it normally requires use of a mounting board on which it is mounted and a mounting space for the extra board. Further, the mounting board entails an additional cost. According to the present embodiment, the antenna is mounted on the board of the inverter 24 so that this board doubles as the board of the antenna element. By doing this, the mounting space for the antenna element and the board cost can be reduced.

At the same time, the second casing 18 of the display unit 3 need not be provided with any dedicated mounting structure for the antenna element. Therefore, the construction and assembly can be simplified, and the mounting space can be reduced. Accordingly, the space in the second casing 18 can be utilized efficiently. More specifically, mounting spaces for antennas that are used for some other radio communication systems, such as the Bluetooth, UWB, GPRS, etc., as well as the space for the antenna for the radio LAN, can be secured in the second casing. Thus, the resulting portable computer 1 can avoid being large-sized without failing to maintain its communication function.

The following is a description of a portable computer according to a second embodiment of the invention. According to the second embodiment, as shown in FIG. 6, an IF/RF circuit 36 of a radio communication device 30, as well as an antenna element 42, is mounted on a printed circuit board 50 of an inverter 24. The antenna element 42 is attached to one end portion of the circuit board 50 with respect to its longitudinal direction, and the IF/RF circuit 36 is located side by side with the antenna element. A chip antenna 68 of the antenna element 42 is connected to the IF/RF circuit 36 by means of a wiring pattern that is formed on the printed circuit board 50.

Other components of the radio communication device 30, that is, a modem 34 and an MAC/base band element 32, are located in a computer body 2 of the portable computer 1. The IF/RF circuit 36 on the printed circuit board 50 is connected to the modem 34 by means of wires 62.

The second embodiment shares other configurations with the first embodiment. Therefore, like reference numerals are used to designate like portions of these embodiments, and a detailed description of those portions will be omitted.

According to the portable computer of the second embodiment, the antenna element 42 is mounted on the board of the inverter 24, so that the same functions and effects of the first embodiment can be obtained. Further, the IF/RF circuit 36 of the radio communication device 30 is mounted on the printed circuit board 50 of the inverter 24 in a second casing 18 of a display unit 3 and connected electrically to the antenna element 42. Therefore, the length of a cable or wires that connect the antenna element 42 and the IF/RF circuit 36 can be made much shorter than in the case where the IF/RF circuit is located on the computer body side. Thus, attenuation of high-frequency signals that are transferred between the antenna element 42 and the IF/RF circuit 36 can be reduced by a large margin. Furthermore, the cost of the cable can be reduced, and noises that are picked up by the cable can be lessened considerably.

While the IF/RF circuit 36 and the modem 34 are connected by means of a cable, signals that are transferred between them are intermediate frequency signals at hundreds of megahertz. Therefore, the degree to which the signals attenuate as they pass through the cable is lower enough than the degree of attenuation of high-frequency signals. Thus, attenuation of signals that are transmitted or received can be reduced, so that the communication performance can be improved.

Since the antenna element 42 and the IF/RF circuit 36 are connected by the wiring pattern that is formed on the printed circuit board 50, the coaxial connector that is relatively large in size can be omitted. Thus, the size and manufacturing cost of the apparatus can be reduced. Further, the peripheral space of a liquid crystal display panel 20 is effectively used in a manner such that the IF/RF circuit 36 is located on the display unit side. Thus, the radio communication device 30 in the computer body 2 can be downsized to reduce its mounting space.

The following is a description of a portable computer according to a third embodiment of the invention. According to this embodiment, as shown in FIG. 7, an IF/RF circuit 36 and a modem 34 of a radio communication device 30, as well as an antenna element 42, are mounted on a printed circuit board 50 of an inverter 24. The antenna element 42 is attached to one end portion of the circuit board 50 with respect to its longitudinal direction, and the IF/RF circuit 36 and the modem 34 are located side by side with the antenna element. A chip antenna 68 of the antenna element 42 is connected to the IF/RF circuit 36 by a wiring pattern that is formed on the printed circuit board 50.

Another component of the radio communication device 30, that is, an MAC/base band element 32, is located in a computer body 2 of the portable computer 1. The modem 34 on the printed circuit board 50 is connected to the MAC/base band element 32 by means of wires 62.

The third embodiment shares other configurations with the first and second embodiments. Therefore, like reference numerals are used to designate like portions of these embodiments, and a detailed description of those portions will be omitted.

According to this portable computer, the antenna element 42, IF/RF circuit 36, and modem 34 are mounted on the board of the inverter 24, so that the same functions and effects of the first and second embodiments can be obtained.

While the modem 34 in the inverter 24 and the MAC/base band element 32 in the computer body 2 are connected by a cable, signals that are transferred between them are low-frequency signals at tens of megahertz. Therefore, the degree to which the signals attenuate as they pass through the cable is lower enough than the degree of attenuation of high-frequency signals. Thus, attenuation of signals that are transmitted or received can be reduced, so that the communication performance can be improved.

Further, the peripheral space of a liquid crystal display panel 20 is effectively used in a manner such that the IF/RF circuit 36 and the modem 34 are located on the display unit side. Thus, the radio communication device 30 in the computer body 2 can be downsized to reduce its mounting space.

The following is a description of a portable computer according to a fourth embodiment of the invention. According to the fourth embodiment, as shown in FIG. 8, an IF/RF circuit 36, modem 34, and MAC/base band element 32 of a radio communication device 30, as well as an antenna element 42, are mounted on a printed circuit board 50 of an inverter 24. The antenna element 42 is attached to one end portion of the circuit board 50 with respect to its longitudinal direction, and the IF/RF circuit 36, modem 34, and MAC/base band element 32 are located side by side with the antenna element. A chip antenna 68 of the antenna element 42 is connected to the IF/RF circuit 36 by means of a wiring pattern that is formed on the printed circuit board 50. The MAC/base band element 32 is connected to an I/F 38 in the computer body 2 by means of wires 62.

The fourth embodiment shares other configurations with the first to third embodiments. Therefore, like reference numerals are used to designate like portions of these embodiments, and a detailed description of those portions will be omitted.

According to the portable computer of the fourth embodiment, the antenna element 42, IF/RF circuit 36, modem 34, and MAC/base band element 32 are mounted on the board of the inverter 24, so that the same functions and effects of the first to third embodiments can be obtained.

While the MAC/base band element 32 in the inverter 24 and the I/F 38 in the computer body 2 are connected by means of a cable, signals that are transferred between them are digital signals. Therefore, the signals attenuate little and are not easily subjected to noises and the like, so that the reliability of operation is improved. Further, the peripheral space of a liquid crystal display panel 20 is effectively used in a manner such that the whole radio communication device 30 is located on the display unit side. Thus, the available space of the computer body 2 can be enlarged.

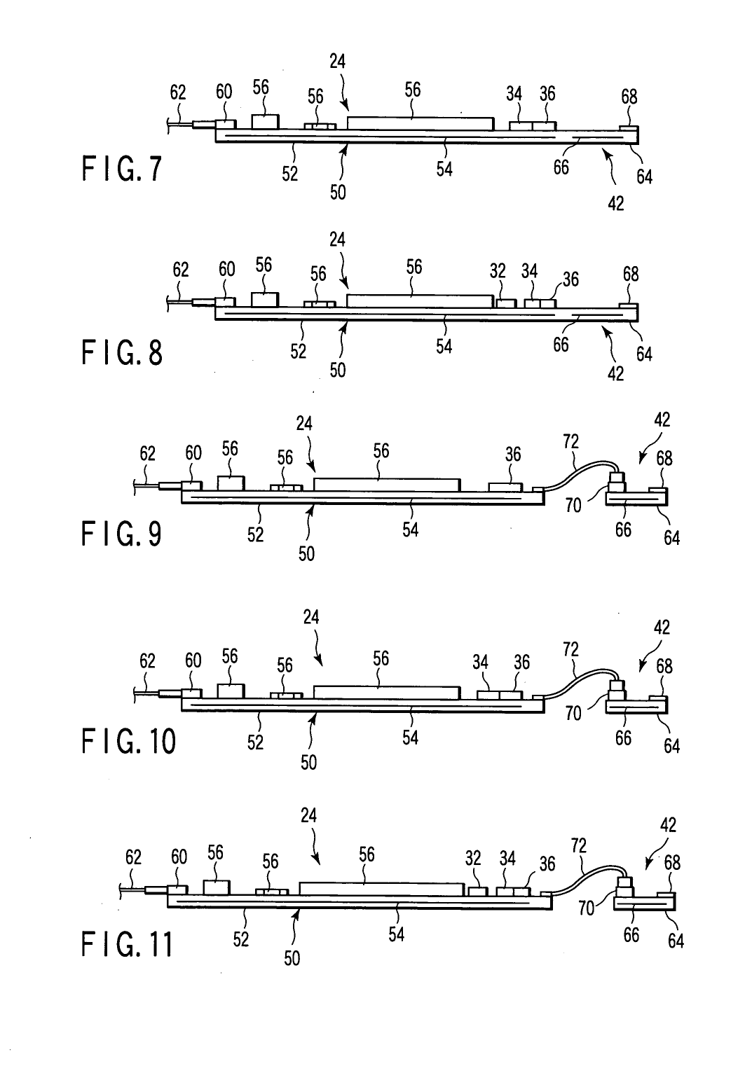

The following is a description of a portable computer according to a fifth embodiment of the invention. According to the fifth embodiment, as shown in FIG. 9, an antenna element 42 has an insulating substrate 64 that is independent of a printed circuit board 50 of an inverter 24. It is located adjacent to the inverter 24 in a second casing of a display unit. A chip antenna 68 and a coaxial connector 70 are mounted on the insulating substrate 64. Further, a ground pattern 66 is formed in the insulating substrate 64. It is connected to the chip antenna 68.

An IF/RF circuit 36 of a radio communication device 30 is mounted on the printed circuit board 50 of the inverter 24. In this case, the circuit 36 is attached to one end portion of the circuit board 50 with respect to its longitudinal direction, which is situated on the side remoter from a connector 60, and more particularly, to one end portion that adjoins the antenna element 42 in the longitudinal direction. The IF/RF circuit 36 is connected to the antenna element 42 by means of a cable 72.

Other components of the radio communication device 30, that is, a modem 34 and an MAC/base band element 32, are located in a computer body 2 of the portable computer. The IF/RF circuit 36 on the printed circuit board 50 is connected to the modem 34 by wires 62.

The fifth embodiment shares other configurations with the first embodiment. Therefore, like reference numerals are used to designate like portions of these embodiments, and a detailed description of those portions will be omitted.

According to the portable computer of the fifth embodiment, the IF/RF circuit 36 is mounted on the board of the inverter 24, so that the length of the cable 72 that connects the antenna element 42 and the IF/RF circuit can be made much shorter than in the case where the IF/RF circuit is located on the computer body side. Thus, attenuation of high-frequency signals that are transferred between the antenna element 42 and the IF/RF circuit 36 can be reduced by a large margin. Furthermore, the cost of the cable can be reduced, and noises that are picked up by the cable can be lessened considerably.

While the IF/RF circuit 36 and the modem 34 are connected by means of a cable, signals that are transferred between them are intermediate frequency signals at hundreds of megahertz. Therefore, the degree to which the signals attenuate as they pass through the cable is lower enough than the degree of attenuation of high-frequency signals. Thus, attenuation of signals that are transmitted or received can be reduced, so that the communication performance can be improved. The peripheral space of a liquid crystal display panel 20 is effectively used in a manner such that the IF/RF circuit 36 is located on the display unit side. Thus, the radio communication device 30 in the computer body 2 can be downsized to reduce its mounting space.

The following is a description of a portable computer according to a sixth embodiment of the invention. According to the sixth embodiment, as shown in FIG. 10, an antenna element 42 has an insulating substrate 64 that is independent of a printed circuit board 50 of an inverter 24. It is located adjacent to the inverter 24 in a second casing of a display unit. A chip antenna 68 and a coaxial connector 70 are mounted on the insulating substrate 64. Further, a ground pattern 66 is formed in the insulating substrate 64. It is connected to the chip antenna 68.

An IF/RF circuit 36 and a modem 34 of a radio communication device 30 are mounted on the printed circuit board 50 of the inverter 24. The circuit 36 is attached to one end portion of the circuit board 50 with respect to its longitudinal direction, which is situated on the side remoter from a connector 60, and more particularly, to one end portion that adjoins the antenna element 42 in the longitudinal direction. The IF/RF circuit 36 is connected to the antenna element 42 by means of a cable 72.

Another component of the radio communication device 30, that is, an MAC/base band element 32, is located in a computer body 2 of the portable computer. The modem 34 on the printed circuit board 50 is connected to the MAC/base band element 32 by means of wires 62.

The sixth embodiment shares other configurations with the first embodiment. Therefore, like reference numerals are used to designate like portions of these embodiments, and a detailed description of those portions will be omitted.

According to the portable computer of the sixth embodiment, the IF/RF circuit 36 is mounted on the board of the inverter 24, so that the length of the cable 72 that connects the antenna element 42 and the IF/RF circuit can be made much shorter than in the case where the IF/RF circuit is located on the computer body side. Thus, attenuation of high-frequency signals that are transferred between the antenna element 42 and the IF/RF circuit 36 can be reduced by a large margin. Furthermore, the cost of the cable can be reduced, and noises that are picked up by the cable can be lessened considerably.

While the modem 34 and the MAC/base band element 32 are connected by means of a cable, signals that are transferred between them are low-frequency signals at tens of megahertz. Therefore, the degree to which the signals attenuate as they pass through the cable is lower enough than the degree of attenuation of high-frequency signals. Thus, attenuation of signals that are transmitted or received can be reduced, so that the communication performance can be improved. The peripheral space of a liquid crystal display panel 20 is effectively used in a manner such that the IF/RF circuit 36 and the modem 34 is located on the display unit side. Thus, the radio communication device 30 in the computer body 2 can be downsized to reduce its mounting space.

The following is a description of a portable computer according to a seventh embodiment of the invention. According to the seventh embodiment, as shown in FIG. 11, an IF/RF circuit 36, modem 34, and MAC/base band element 32 of a radio communication device 30 are mounted on a printed circuit board 50 of an inverter 24. The circuit 36 is attached to one end portion of the circuit board 50 with respect to its longitudinal direction, which is situated on the side remoter from a connector 60, and more particularly, to one end portion that adjoins the antenna element 42 in the longitudinal direction. The IF/RF circuit 36 is connected to the antenna element 42 by means of a cable 72. The modem 34 and the MAC/base band element 32 are located side by side with the IF/RF circuit 36.

The seventh embodiment shares other configurations with the sixth embodiment. Therefore, like reference numerals are used to designate like portions of these embodiments, and a detailed description of those portions will be omitted.

According to the portable computer of the seventh embodiment, IF/RF circuit 36, modem 34, and MAC/base band element 32 of the radio communication device 30 are mounted on the board of the inverter 24, so that the same functions and effects of the fifth and sixth embodiments can be obtained.

While the MAC/base band element 32 in the inverter 24 and an I/F 38 in the computer body 2 are connected by means of a cable, signals that are transferred between them are digital signals. Therefore, the signals attenuate little and are not easily subjected to noises and the like, so that the reliability of operation is improved. Further, the peripheral space of a liquid crystal display panel 20 is effectively used in a manner such that the whole radio communication device 30 is located on the display unit side. Thus, the available space of the computer body 2 can be enlarged.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents. For example, some of the components according to the foregoing embodiments may be omitted. Further, the components according to the different embodiments may be combined suitably.

In the display unit of the portable computer described above, two fluorescent lamps, instead of one, may be used as light sources. In this case, each fluorescent lamp may be provided with an inverter, or the two fluorescent lamps may be driven by means of a single inverter. Further, radio communication devices and antenna elements may be provided in a plurality of sets instead of one. The same functions and effects as aforesaid may be obtained by mounting at least one antenna element or at least one component of a radio communication device, out of those sets, on the board of the inverter.

The mounting position of the antenna element or the radio communication device on the circuit board of the inverter is not restricted to the one end portion with respect to the longitudinal direction, and may be selected variously as required. In the foregoing embodiments, moreover, the printed circuit board of the inverter is used as an example of the circuit board for the display panel. Alternatively, however, the printed circuit board of a driver circuit 25 may be used as the circuit board for the display panel so that the antenna element and/or the radio communication device is mounted on the printed circuit board.

According to the embodiments described above, the radio LAN is used for the radio communication function. Alternatively, however, a radio communication device of the Bluetooth or other system may be applied to this function. Furthermore, the present invention is not limited to portable computers that comprises a computer body and a display unit, and may be also applied to some other electronic apparatuses, such as a PDA (personal digital assistant) in which an apparatus body and a display unit share a casing.

What is claimed is:

1. An electronic apparatus comprising:
a casing;
a display panel located in the casing;
a circuit board for the display panel located in the casing;
an antenna element mounted on the circuit board in the casing; and
a radio communication device connected to the antenna element.

2. An electronic apparatus according to claim 1, wherein the radio communication device includes an RF portion mounted on the circuit board in the casing.

3. An electronic apparatus according to claim 1, wherein the antenna element has a ground pattern formed on the circuit board, and an antenna mounted on the circuit board and connected to the ground pattern.

4. An electronic apparatus according to claim 3, wherein the circuit board has another ground pattern formed on the circuit board and connected to said ground pattern of the antenna element.

5. An electronic apparatus according to claim 1, further comprising a light source which is located in the casing and illuminates the display panel, and an inverter mounted on the circuit board and configured to drive the light source.

6. An electronic apparatus comprising:
a casing;
a display panel located in the casing;
a circuit board for the display panel located in the casing;
an antenna element arranged in the casing; and
a radio communication device, in the case, connected to the antenna element and including an RF portion mounted on the circuit board.

7. An electronic apparatus according to claim 6, further comprising a light source which is located in the casing and illuminates the display panel, and an inverter mounted on the circuit board and configured to drive the light source.

8. An electronic apparatus comprising:
an apparatus body;
a display unit including a casing supported on the apparatus body, a display panel located in the casing, and a circuit board for the display panel located in the casing;
an antenna element arranged in the casing; and
a radio communication device having an RF portion which is arranged in the casing and connected to the antenna element.

9. An electronic apparatus according to claim 8, wherein the RF portion is mounted on the circuit board in the casing.

10. An electronic apparatus according to claim 8, further comprising a light source which is located in the casing and illuminates the display panel, and an inverter mounted on the circuit board and configured to drive the light source.
